(19) United States
(12) Patent Application Publication
(10) Pub. No.: US 2025/0361630 A1
(43) Pub. Date: Nov. 27, 2025

(54) ELECTROLYZER HAVING AN ANODE-SIDE CATALYST AND RELATED METHODS

(71) Applicant: Georgia Tech Research Corporation, Atlanta, GA (US)

(72) Inventors: Seung Woo LEE, Marietta, GA (US); Hyun JU, Suwon-si, Gyeonggi-do (KR); Jinho PARK, Johns Creek, GA (US)

(21) Appl. No.: 18/874,196

(22) PCT Filed: Jun. 22, 2023
(86) PCT No.: PCT/US2023/068887

§ 371 Date: Dec. 12, 2024

Related U.S. Application Data
(60) Provisional application No. 63/354,916, filed on Jun. 23, 2022.

(51) Int. Cl. C25B 11/075; C25B 1/04; C25B 9/23; C25B 11/032; C25B 11/052; C25B 11/065

(52) U.S. Cl. CPC C25B 11/075; C25B 1/04; C25B 9/23; C25B 11/032; C25B 11/052; C25B 11/065

(57) ABSTRACT

An electrolyzer system includes a cathode comprising a cathode catalyst: an anode comprising an anode catalyst configured to promote oxidation of water: and a proton exchange membrane (PEM) between the cathode and the anode, wherein the cathode, anode, and proton exchange membrane are configured such that water at the anode reacts to form oxygen and positively charged hydrogen ions, and the positively charged ions react at the cathode to form hydrogen (H₂): wherein the catalyst comprises a Y₂Ru₂O₇—NaBH₄ catalyst.

### REFERENCE TO PRIORITY APPLICATION

The present application claims priority to U.S. Provisional Application 63/354,916, filed Jun. 23, 2023, the disclosure of which is hereby incorporated herein by reference.

### FIELD OF THE INVENTION

The present invention relates to electrolyzers for producing hydrogen, and in particular, to a proton exchange membrane electrolyzer having an anode-side catalyst for the production of hydrogen.

### BACKGROUND OF THE INVENTION

In order for the adoption of renewable energy sources to be successful, energy storage technologies may be needed, e.g., to store or transport surplus electricity from renewable energy sources. Electricity from renewable energy sources may be stored as hydrogen, which can be produced from water. Hydrogen has a high energy content and is also a light weight and clean fuel. Hydrogen may be produced by the electrolysis of water, which is a well-established technique for converting electricity into hydrogen using water.

Water electrolysis dissociates water molecules into hydrogen and oxygen gases by applying electrical energy. Two common examples of water electrolysis are alkaline electrolyzers and proton exchange membrane electrolyzers (PEM). Anion exchange membrane (AEM) electrolysis is an emerging technique for water electrolysis and combines some of the advantages of alkaline and PEM electrolysis. However, increases in efficiency in electrolysis techniques may be desirable to increase the economic impact of renewable energy sources. In particular, current anode-side catalysts typically include precious metals, such as Ruthenium or Iridium (typically IrO₂). Effective and durable catalysts are needed at reduced costs without requiring expensive precious metals.

### SUMMARY OF THE INVENTION

In some embodiments, an electrolyzer system includes a cathode comprising a cathode catalyst; an anode comprising an anode catalyst configured to promote oxidation of water; and a proton exchange membrane (PEM) between the cathode and the anode, wherein the cathode, anode, and proton exchange membrane are configured such that water at the anode reacts to form oxygen and positively charged hydrogen ions, and the positively charged ions react at the cathode to form hydrogen (H₂); wherein the catalyst comprises a Y₂Ru₂O₇—NaBH₄ catalyst.

In some embodiments, a method of forming a catalyst for an electrolyzer system is provided. The electrolyzer system includes a cathode comprising a cathode catalyst, an anode, and a proton exchange membrane (PEM) between the cathode and the anode, and the cathode, anode, and proton exchange membrane are configured such that water at the anode reacts to form oxygen and positively charged hydrogen ions, and the positively charged ions react at the cathode to form hydrogen (H₂). The method includes forming Y₂Ru₂O₇ pyrochlore oxide nanoparticles; and performing a chemical reduction procedure on the Y₂Ru₂O₇ pyrochlore oxide nanoparticles using NaBH₄ to thereby form an anode catalyst comprises an Y₂Ru₂O₇—NaBH₄ nanoparticles.

### BRIEF DESCRIPTION OF THE DRAWINGS

FIG. 1 is a cross-sectional view of a proton exchange membrane electrolyzer according to some embodiments.

FIG. 2 is a graph of X-ray Crystallography (XRD) for Y₂Ru₂O₇ pyrochlore oxide nanoparticles and Y₂Ru₂O₇—NaBH₄ nanoparticles showing the intensity of x-rays scattered at different angles by the sample.

FIG. 3 is a graph of the binding energy (eV) of Y₂Ru₂O₇ pyrochlore oxide nanoparticles and Y₂Ru₂O₇—NaBH₄ nanoparticles as a function of intensity for oxygen vacancies, lattice oxygen, surface oxygen species, adventitious species.

FIG. 4 is a transmission electron microscopy image of Y₂Ru₂O₇ pyrochlore oxide nanoparticles.

FIG. 5 is a transmission electron microscopy image of Y₂Ru₂O₇—NaBH₄ nanoparticles.

FIG. 6 is a graph of LSV (linear sweep voltammetry) curves of the Y₂Ru₂O₇—NaBH₄, Y₂Ru₂O₇ and commercial IrO₂.

FIG. 7 is a graph of a chronoamperometric test to test the durability of the catalyst and illustrates the current density value at a constant potential as a function of time.

### DETAILED DESCRIPTION OF EMBODIMENTS

The present invention now will be described more fully with reference to the accompanying drawings, in which preferred embodiments of the invention are shown. This invention may, however, be embodied in many different forms and should not be construed as being limited to the embodiments set forth herein; rather, these embodiments are provided so that this disclosure will be thorough and complete, and will fully convey the scope of the invention to those skilled in the art. Like reference numerals refer to like elements throughout.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer, or section. Thus, a first element, component, region, layer, or section discussed below could be termed a second element, component, region, layer, or section without departing from the teachings of the present invention.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprising”, “including”, “having” and variants thereof, when used in this specification, specify the presence of stated features, steps, operations, elements, and/or components, but do not preclude the presence or addition of one or more other features, steps, operations, elements, components, and/or groups thereof. In contrast, the term “consisting of” when used in this specification, specifies the stated features, steps, operations, elements, and/or components, and precludes additional features, steps, operations, elements and/or components.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

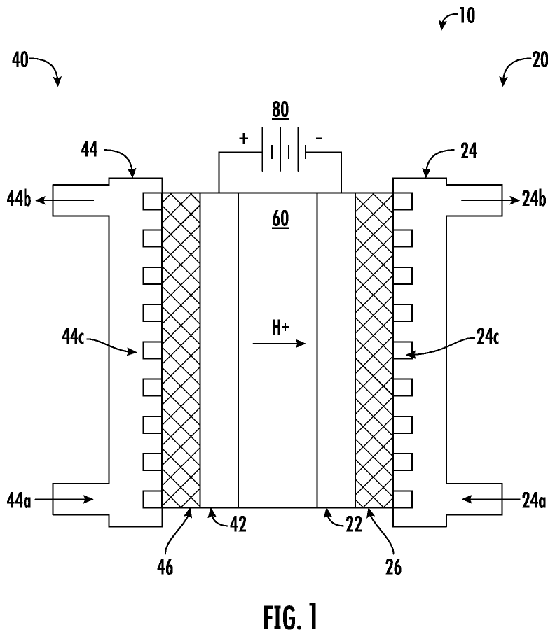

Referring to FIG. 1, a proton exchange membrane (PEM) water electrolysis system 10 is shown. The PEM water electrolysis system 10 includes a cathode 20 that has a catalyst 22, a distribution plate 24, and a diffusion layer 26. The PEM water electrolysis system 10 also includes an anode 40 that includes a catalyst 42, a distribution plate 44, and a diffusion layer 46. The anode 40 is configured to promote oxidation of water. A proton electrolyte membrane (PEM) 60 is between the cathode 20 and the anode 40. The cathode 20, anode 40, and proton electrolyte membrane (PEM) 60 are configured such that water introduced at the anode 40 reacts to form oxygen and positively charged hydrogen ions. A current source 80 is configured to drive an electrical current between the cathode 20 and the anode 40. The oxygen may exit the distribution plate 44 at the outlet 44b. The positively charged hydrogen ions travel through the proton electrolyte membrane (PEM) 60, react at the cathode to form hydrogen (H₂), which exits the outlet 24b of the cathode 20.

In particular, the water reacts at the anode as follows:

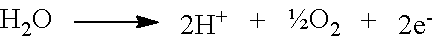

At the cathode, the positive hydrogen ions react as follows:

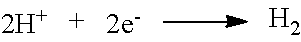

Accordingly, the overall reaction is

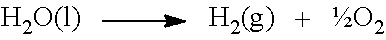

The current source 80 may be an external circuit electrically connecting the cathode 20 and anode 40 and configured such that electrons flow through the external circuit and the hydrogen ions formed at the anode 40 selectively move across the proton electrolyte membrane (PEM) 60 to the cathode 20, and at the cathode 20, hydrogen ions combine with electrons from the external circuit to thereby form hydrogen gas. The current source 80 may be provided by a clean energy source, such as solar cells or wind turbines.

The proton exchange membrane (PEM) 60, which may also be referred to as a polymer-electrolyte membrane (PEM), is a semipermeable membrane typically formed from ionomers and configured to conduct protons while acting as an electronic insulator and reactant barrier to oxygen and hydrogen gas. Thus, the proton exchange membrane (PEM) 60 transports protons while not permitting a direct electronic pathway through the proton exchange membrane (PEM) 60. The proton exchange membrane (PEM) 60 may be formed of a pure polymer membrane or from composite membranes in which materials are embedded in a polymer matrix. Examples of proton exchange membrane (PEM) materials include the fluoropolymer or perfluorosulfonic acid (PFSA) commercially available under the tradename Nafion™, available from DuPont. However, any suitable proton exchange membrane (PEM) may be used. In some embodiments, the proton exchange membrane (PEM) is a thin membrane, e.g., less than 100 μm, or between about 5 μm and 70 μm; however, the proton exchange membrane (PEM) may be as thick as about 170 μm. Moreover, it should be understood that proton exchange membrane (PEM) water electrolysis system 10 may be stacked with other PEM water electrolyzers to form a PEM water electrolyzer stack.

The cathode 20 may be formed of or include metal catalyst particles (e.g., nanoparticles) that may be unsupported or supported on a conductive substrate, such as carbon or carbon particles and/or an anion-conducting polymer. An example of a suitable cathode is a carbon supported platinum catalyst. For example, the diffusion layer 26 may be a porous carbon sheet coated with a metal, such as the platinum catalyst, deposited or electroplated thereon and may be configured to permit efficient current distribution while also connecting the cathode catalyst 22 to the distribution plate 24. The distribution plate 24 may be formed of a conductive material. The catalyst 22 may be formed as a catalyst layer on the cathode diffusion layer 26. In some embodiments, the catalyst 22 may be platinum nanoparticles supported on conductive carbon, and the diffusion layer 26 may be a gas diffusion layer including carbon paper made of carbon fibers; however, any suitable material may be used. The cathode side distribution plate 24 includes an optional inlet 24a for a water input and an outlet 24b for water and hydrogen. The cathode side distribution plate 24 also includes channels 24c for transporting water to/from the diffusion layer 26.

The anode 40 includes an anode diffusion layer 46 and the catalyst 42 is formed as a catalyst layer on the anode diffusion layer 46. The anode side distribution plate 44 with an inlet 44a for a water input and an outlet 44b for water and oxygen, and channels 44c for transporting and delivering the water to/from the diffusion layer 46. The diffusion layers 26, 46 may be graphitized carbon layers (e.g., carbon paper made of carbon fibers) sandwiched between the catalysts 22, 42 and the distribution plates 24, 44.

The proton exchange membrane (PEM) 60 contacts the anode catalyst 42 on one side thereof and the proton exchange membrane (PEM) 60 contacts the cathode catalyst 22 on an opposite side thereof.

### Anode Catalyst

The anode catalyst 42 includes a Y₂Ru₂O₇—NaBH₄ catalyst. The Y₂Ru₂O₇—NaBH₄ catalyst comprises Y₂Ru₂O₇ pyrochlore oxide nanoparticles treated with a sodium borohydride (NaBH₄) solution. In some embodiments, the Y₂Ru₂O₇—NaBH₄ catalyst comprises nanoparticles having a diameter ranging from about 20 to about 300 nm. The anode catalyst 42 may be formed as a layer applied to the diffusion layer 46 (e.g., a graphitized carbon layer).

Ruthenate pyrochlore oxide is an example of a special metal oxide catalyst that may have a high potential for use in water splitting and may be an alternative to commercially available precious-metal catalysts, such as Ruthenium and Iridium.

Without wishing to be bound by any particular theory, controlling the surface oxygen vacancy in Yttrium ruthenate pyrochlores (YRO) may manipulate the intrinsic electronic structure of the material, which may result in enhanced catalytic activity and durability. Surface oxygen vacancy may be introduced using a chemical reduction method with NaBH₄, and an increase in performance may be achieved with optimized oxygen vacancy content. The oxygen vacancy rate of the NaBH₄-treated YRO or Y₂Ru₂O₇ was increased by about 16% after the NaBH₄ treatment. The degree of surface oxygen vacancies in Y₂Ru₂O₇ may be controlled by increasing or decreasing a concentration of NaBH₄ in a solution applied to Y₂Ru₂O₇ nanoparticles as described below. Oxygen vacancy content may be optimized or approximately optimized by controlling the crystal structure-electrochemical properties of NaBH₄ treated materials. If the oxygen vacancy content is too high, e.g., du to a high concentration of NaBH₄ solution being used in the processes described herein, the crystal structures of the Y₂Ru₂O₇ may be negatively impacted or destabilized. Accordingly, the concentration of NaBH₄ solution and Y₂Ru₂O₇ quantities may be experimentally determined to increase oxygen vacancies without negatively impacting or destroying the crystal structures of Y₂Ru₂O₇.

Moreover, the catalytic activity of oxygen vacancy-controlled ruthenate pyrochlores, YRO—NaBH₄, outperformed IrO₂, a standard anode catalyst, by as much as 200%. The catalytic activity of oxygen vacancy-controlled ruthenate pyrochlores was measured overpotential at a current density of 10 mA cm². IrO₂ is a conventional benchmark catalyst for an oxygen evolution reaction, or the half reaction of water splitting. YRO—NaBH₄ also outperformed pristine ruthenate pyrochlores. The catalytic activity at a current density of 1.55 V vs RHE of the vacancy-controlled YRO (YRO—NaBH₄) increase by about 58% relative to untreated YRO and was also about 3.8-fold higher than that of convention IrO₂ in catalyzing the oxygen evolution reaction.

Nonlimiting examples of Y₂Ru₂O₇—NaBH₄ catalyst and methods of forming the same are described below.

Synthesis of Y₂Ru₂O₇ Pyrochlore Oxide Nanoparticles in Anode Catalyst Layer

Y₂Ru₂O₇ pyrochlore oxide nanoparticles were synthesized by using a sol-gel method. First, a neutral (pH=7) buffer solution with a mixture of a 1 M ammonia solution, 3.42×10⁻² mol of anhydrous ethylenediaminetetraacetic acid, and 1.5 mL of nitric acid was prepared. Next, 0.3148 g (0.000822 mol) of Yttrium (III) nitrate hexahydrate (Y(NO₃)₃·6H₂O, 99.8% trace metals basis, MW=383.01 g mol⁻¹), 5.08 mL (0.000822 mol) of Ruthenium (III) nitrosyl nitrate solution (Ru(NO)(NO₃)ₓ(OH)_{y}, x+y=3, 1.5 wt. % Ru), and 8 g of citric acid (C₆H₈O₇, 99%, MW=192.124 g mol⁻¹) were dissolved and stirred with 250 mL of buffer solution for 24 h at 150° C. Gelled solution was obtained after 24 h at 150° C. in the oil-bath reactor, which will be dried in an oven at 200° C. for 12 h. The solid-state product was pulverized into powder that was calcined at 1000° C. for 8 h in air atmosphere to produce crystalline Y₂Ru₂O₇ pyrochlore oxide nanoparticles. After that, the product was centrifuged and washed with deionized (DI) water several times. Finally, the resulting Y₂Ru₂O₇ pyrochlore oxide nanoparticles were dried under vacuum overnight at 60° C.

Surface Reduction of Synthesized Pyrochlore Oxide (Y₂Ru₂O₇—NaBH₄) Catalyst

Y₂Ru₂O₇—NaBH₄ was fabricated by a simple, energy efficient, and scalable chemical method. Different concentrations (0 to 5 M) of sodium borohydride (NaBH₄) solution with ethanol as a solvent was used as a chemical reducing agent, and the 0.5 g of pyrochlore oxide powder was immersed into the solutions for three hours at room temperature. During the reduction procedure, oxygen defects were introduced on the surface of pyrochlore oxides. Next, the reduced product was washed with DI water and ethanol several times. Finally, the Y₂Ru₂O₇—NaBH₄ sample was prepared after drying in a vacuum oven overnight at 60° C.

Both Y₂Ru₂O₇ and Y₂Ru₂O₇—NaBH₄ have the size ranges of 20-300 nm.

NaBH₄ reduces the surface of Y₂Ru₂O₇, which results in making oxygen vacancies on the crystal structure of Y₂Ru₂O₇ at the surface.

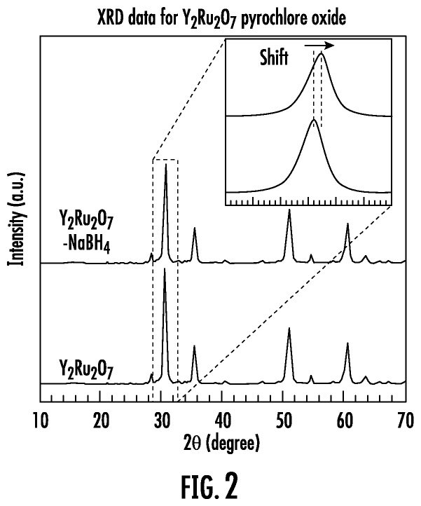

FIG. 2 shows the XRD (X-ray diffraction) result of the Y₂Ru₂O₇ and Y₂Ru₂O₇—NaBH₄. Both Y₂Ru₂O₇ and Y₂Ru₂O₇—NaBH₄ had almost same peak shapes except slight peak shift in the inset of figure. The peak was shifted slightly to higher angle after NaBH₄ treatment due to the generated oxygen vacancy. The oxygen vacancy leads to the reduced distances between the atoms, resulting in the increased 20 value based on the Bragg's equation where distance and 20 values are inversely proportional.

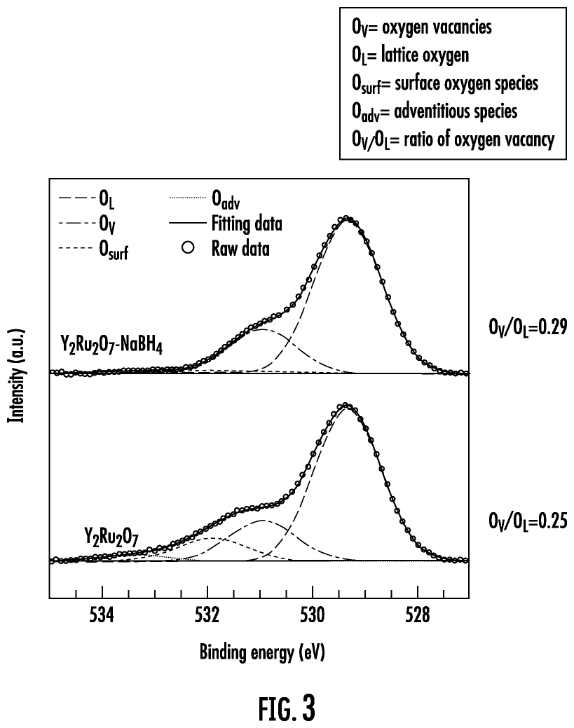

FIG. 3 presents the XPS (X-ray photoelectron spectroscopy) result of the Y₂Ru₂O₇ and Y₂Ru₂O₇—NaBH₄. O_{V}, O_{L}, O_{surf}, O_{adv} indicate the oxygen vacancies, lattice oxygen, surface oxygen species, adventitious species of the Y₂Ru₂O₇ and Y₂Ru₂O₇—NaBH₄, respectively. O_{V}/O_{L} is the ratio of oxygen vacancy relative to lattice oxygen content. The Oxygen vacancy content of Y₂Ru₂O₇ was increased after the NaBH₄ treatment.

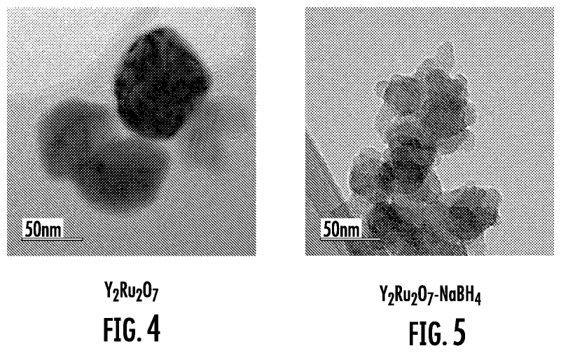

FIGS. 4 and 5 shows the TEM (transmission electron microscopy) images of the Y₂Ru₂O₇ (FIG. 4) and Y₂Ru₂O₇—NaBH₄ (FIG. 5). After the NaBH₄ treatment, the particles had higher oxygen vacancy content without collapse of their structures. However, the size of the nanoparticles are similar.

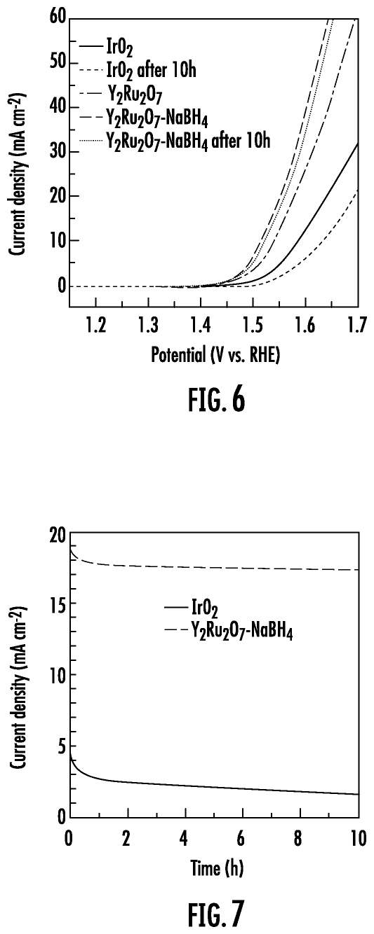

FIGS. 6 and 7 demonstrate the electrochemical activity and durability performances of the Y₂Ru₂O₇—NaBH₄, Y₂Ru₂O₇ and commercial IrO₂. FIG. 6A is LSV (linear sweep voltammetry) curves of the Y₂Ru₂O₇—NaBH₄, Y₂Ru₂O₇ and commercial IrO₂. Highly active catalyst indicates the curve with lower potential value at a certain current density and higher current density value at a certain potential. Y₂Ru₂O₇—NaBH₄ outperformed the pristine Y₂Ru₂O₇ and reference IrO₂ catalysts. FIG. 7 shows the chronoamperometric test, which is one of the electrochemical durability tests. In this experiment, current density value can be recorded at a constant potential. The Y₂Ru₂O₇—NaBH showed outstanding durability maintaining high current density for 10 hours whereas the IrO₂ catalyst revealed gradual degradation of current density value in an entire time range. After the 10-h durability test, a significant difference of catalytic activity curves of Y₂Ru₂O₇—NaBH₄ and IrO₂ were shown in FIG. 6.

TABLE

| | Potential at current | Current density | |
|---|---|---|---|
| | density of 10 mA cm⁻² | at 1.55 V vs. RHE | |
| YRO | 1.541 V | 12.0539 | mA cm⁻² |
| IrO₂ | 1.589 V | 5.0372 | mA cm⁻² |
| IrO₂ after 10 h | 1.633 V | 1.9073 | mA cm⁻² |
| Y₂Ru₂O₇-NaBH₄ | 1.518 V | 18.925 | mA cm⁻² |
| Y₂Ru₂O₇-NaBH₄ after 10 h | 1.524 V | 17.2406 | mA cm⁻² |

The Table above shows the specific potential and current density values of the samples before and after the durability test. Y₂Ru₂O₇—NaBH₄ had lowest potential of 1.518 V vs. RHE at a current density of 10 mA cm⁻², and Y₂Ru₂O₇—NaBH₄ also produced highest current density value of 18.925 mA cm⁻², 1.5 and 3.7 times greater than pristine Y₂Ru₂O₇ (12.054) and commercial IrO₂ (5.037).

In the drawings and specification, there have been disclosed typical preferred embodiments of the invention and, although specific terms are employed, they are used in a generic and descriptive sense only and not for purposes of limitation, the scope of the invention being set forth in the following claims.

That which is claimed is:

1. An electrolyzer system comprising:
a cathode comprising a cathode catalyst;
an anode comprising an anode catalyst configured to promote oxidation of water; and
a proton exchange membrane (PEM) between the cathode and the anode, wherein the cathode, anode, and proton exchange membrane are configured such that water at the anode reacts to form oxygen and positively charged hydrogen ions, and the positively charged ions react at the cathode to form hydrogen (H₂);
wherein the catalyst comprises a Y₂Ru₂O₇—NaBH₄ catalyst.

2. The electrolyzer system of claim 1, wherein the Y₂Ru₂O₇—NaBH₄ catalyst comprises Y₂Ru₂O₇ pyrochlore oxide nanoparticles treated with a sodium borohydride (NaBH₄) solution.

3. The electrolyzer system of claim 1, wherein the Y₂Ru₂O₇—NaBH₄ catalyst comprises nanoparticles having a diameter ranging from about 20 to about 300 nm.

4. The electrolyzer system of claim 1, further comprising an external circuit electrically connecting the anode and cathode and configured such that electrons flow through the external circuit and the hydrogen ions formed at the anode selectively move across the proton exchange membrane (PEM) to the cathode, and at the cathode, hydrogen ions combine with electrons from the external circuit to thereby form hydrogen gas.

5. The electrolyzer system of claim 1, wherein the anode comprises an anode diffusion layer and the anode catalyst comprises an anode catalyst layer of Y₂Ru₂O₇—NaBH₄ nanoparticles on the anode diffusion layer.

6. The electrolyzer system of claim 5, wherein the cathode comprise a cathode diffusion layer and a cathode catalyst layer on the cathode diffusion layer.

7. The electrolyzer system of claim 6, wherein the proton exchange membrane (PEM) contacts the anode diffusion layer on one side thereof and the proton exchange membrane (PEM) contacts the cathode diffusion layer on an opposite side thereof, and the anode diffusion layer and the cathode diffusion layer each comprise a graphitized carbon layer.

8. The electrolyzer system of claim 7, further comprising:
an anode side distribution plate with an inlet for a water input and an outlet for water and oxygen, the anode side distribution plate being configured to feed water to the anode diffusion layer; and
a cathode side distribution plate with an optional inlet for a water input and an outlet for water and hydrogen, the cathode side distribution plate optionally being configured to feed water to the cathode diffusion layer.

9. The electrolyzer system of claim 1, further comprising a direct current source configured to drive an electrical current between the cathode and the anode.

10. A method of forming a catalyst for an electrolyzer system, the electrolyzer system comprising a cathode comprising a cathode catalyst, an anode, and a proton exchange membrane (PEM) between the cathode and the anode, wherein the cathode, anode, and proton exchange membrane are configured such that water at the anode reacts to form oxygen and positively charged hydrogen ions, and the positively charged ions react at the cathode to form hydrogen (H₂), the method comprising:
forming Y₂Ru₂O₇ pyrochlore oxide nanoparticles; and
performing a chemical reduction procedure on the Y₂Ru₂O₇ pyrochlore oxide nanoparticles using NaBH₄ to thereby form an anode catalyst comprises a Y₂Ru₂O₇—NaBH₄ nanoparticles.

11. The method of claim 10, further comprising applying the Y₂Ru₂O₇—NaBH₄ nanoparticles to an anode diffusion layer, the anode diffusion layer.

12. The method of claim 11, wherein the anode diffusion layer comprises a graphitized carbon layer.

13. The method of claim 10, wherein forming the Y₂Ru₂O₇ pyrochlore oxide nanoparticles comprises a sol-gel method.

14. The method of claim 13, wherein the sol-gel method comprises dissolving Yttrium (III) nitrate hexahydrate (Y(NO₃)₃·6H₂O and Ruthenium (III) nitrosyl nitrate solution (Ru(NO)(NO₃)ₓ(OH)_{y}, x+y=3 in a buffer solution comprising ammonia, anhydrous ethylenediaminetetraacetic acid, and nitric acid and placing the solution in an oil-bath reactor to thereby produce a gelled solution.

15. The method of claim 14, further comprising drying the gelled solution, forming a powder after drying the gelled solution, and calcinating the powder to produce crystalline Y₂Ru₂O₇ pyrochlore oxide.

16. The method of claim 10, wherein performing a chemical reduction procedure on the Y₂Ru₂O₇ pyrochlore oxide nanoparticles using NaBH₄ to thereby form an anode catalyst comprises a Y₂Ru₂O₇—NaBH₄ nanoparticles comprises combining Y₂Ru₂O₇ pyrochlore oxide in the form of a crystalline powder in a NaBH₄ solution.

17. The method of claim 10, wherein the Y₂Ru₂O₇—NaBH₄ catalyst comprises nanoparticles having a diameter ranging from about 20 to about 300 nm.
